(19) United States
(12) Patent Application Publication
(10) Pub. No.: US 2005/0050951 A1
(43) Pub. Date: Mar. 10, 2005

(54) Valve stem cap remover

(76) Inventor: Arlindo Texiera Jardin, Stoughton, MA (US)

Correspondence Address: Antoinette F. Trotta, 439 Highland Street, Stoughton, MA, 02072, US

(21) Appl. No.: 10/656,480

(22) Filed: Sep. 4, 2003

(51) Int. Cl. G01M 17/02

(52) U.S. Cl. 73/146

(57) ABSTRACT

The tire stem cap remover of the present invention provides a device capable of accessing, loosening, retaining and reinstalling tire valve stem caps on plural arrangements of pneumatic tires mounted on an axel with the tires at the end of the axel. The main body of the present invention consists of an elongated cylindrical rod. The cap-engaging receptacle is comprised of a socket-type cylindrical receptacle with an open end for receiving and engaging the tire valve stem-cap. The cap-engaging receptacle is affixed to the top end of the elongated cylindrical rod.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to pneumatic tire valve stem caps, specifically the removing, retaining, and reinstalling of said tire valve stem caps on vehicles having more than a single axel with a plurality of pneumatic tires mounted at the end of each axel.

2. Description of Prior Art

Maintaining correct tire pressure can provide safer, smoother vehicle handling, contribute to better fuel mileage, and can aid in reducing tire-tread wear. In order to maintain a recommended pressure level, tire pressure must be measured and adjusted on a periodic basis. Typically, tire pressure is measured by removing the tire valve stem cap and measuring the tire pressure with an air gauge. Tire pressure can then be adjusted by either increasing it with the addition of compressed air or decreasing it by depressing the release pin on the tire valve core. After measuring and adjusting the tire pressure, the tire valve stem cap is reinstalled in order to protect the valve core from corrosion and collecting debris resulting in possible damage to the valve core.

In performing these operations, valve stem caps are generally removed by hand. Subsequently, the removed valve stem caps are then set aside or held by the person performing the task in their hand, mouth, or pocket. Once the task is performed the caps must then be retrieved and reinstalled by hand.

Unfortunately, there area number of disadvantages inherent in the aforementioned process:

a) The present process of removing the valve stem cap can be difficult if caps are inaccessible due to the configuration, location, angle of the wheel, or the wheel cover, especially on vehicles having more than a single axel with a plurality of pneumatic tires mounted at the end of each axe[. Access and removal of valve stem caps can become difficult, frustrating and in some cases a safety issue. U.S. Pat. No. 5,614,669 to Sopcisal 1997 discloses a combination air pressure gauge with dust cap remover, however, this device is designed for single mount tires as found on most passenger vehicles and cannot adequately address the need of the plural tire axel mounted arrangement as found on many trucks, trailers, buses, recreational vehicles, and motor homes. Thus, for a vehicle having more than a single axel with a plurality of tires mounted at the end of the axel this device is useless.

b) The present process requires that the removed valve stem cap be set aside or held by the person performing the task in their hand, mouth, or pocket. The handling of the removed valve stem cap inherent in the process is not only time consuming but can also result in misplaced or lost valve stem caps. Efforts to locate or replace lost valve stem caps can waist additional time and failure to install a valve stem cap can lead to valve core corrosion, damage, and in commercial use vehicles possible fines. Additionally, the direct handling of the valve stem cap required by the present process may involve contact with valve stem caps that are wet, corroded or dirty. This can result in the undesired soiling of the person's hands, clothes, and so forth. Prior art provides a device for use on single mount tires but is not adaptable to the needs of a plurality of pneumatic tires mounted on an axel with the tires at the end of the axel, especially in the situation of accessing the inner tires. In addition, in a tire arrangement with a plurality of pneumatic tires mounted at the end of each axel, to access the inside tires sometimes entails significant difficulty requiring significant physical exertion and oftentimes necessitates crawling under the vehicle itself thus adding or increasing the safety risk to the person performing the task. The prior art device by the nature of its deign is incapable of accessing the inner tire and therefore is useless in facilitating or eliminating the above described situation.

(c) The present process of reinstalling removed tire vale stem caps by hand can be difficult if the tire valves are inaccessible due to the configuration, location, angle of the wheel, or the wheel cover, especially on a plural arrangement of pneumatic tires mounted on an axel with the tires at the end of each axel. This can be both frustrating and time consuming. By the nature of its design the prior art device is inadequate for use in the plural tire arrangement of pneumatic tires mounted on an axel with the tires at the end of each axel.

### OBJECTS AND ADVANTAGES

To eliminate the disadvantages inherent in the present process the specifically designed invention provides a device capable of accessing as well as removing, retaining and reinstalling tire valve stem caps on a vehicle having a plurality of pneumatic tires mounted on an axel with the tires at the end of the axel.

Accordingly, several object and advantages of the present invention are:

(a) To provide a device that can facilitate access to the tire valve stem cap on a vehicle having a plurality of pneumatic tires mounted on an axel with the tires at the end of the axel.

(b) To provide a device that can remove and retain the tire valve stem cap from a vehicle having a plurality of pneumatic tires mounted on an axel with the tires at the end of the axel.

(c) To provide a device that can reinstall the tire valve stem cap on a vehicle having a plurality of pneumatic tires mounted on an axel with the tires at the end of the axel.

Further object and advantages of the present invention is to provide a device, which can be used to easily and conveniently access, remove, retain and reinstall tire valve stem caps on a plurality of pneumatic tires mounted on an axel with the tires at the end of the axel.

Still another advantage of the present invention is to provide a device which eliminates the need to either reposition the vehicle or to be physically positioned under the vehicle to access the inner tire valve stem cap on a plurality of pneumatic tires mounted on an axel with the tires at the end of the axel.

Another advantage of the present invention is to provide a device, which can be grasped and rotated in the user's hand.

### SUMMARY

In accordance with the present invention a tire valve stem cap remover comprises an elongated cylindrical rod type body having a tire valve stem cap-engaging receptacle attached at the top and a gripping surface attached at the bottom.

### DESCRIPTION OF THE SEVERAL VIEWS OF THE DRAWINGS

FIG. 1 is a plan view of the valve stem cap remover of the present invention.

FIG. 2 is a perspective view of the valve cap-engaging receptacle.

FIG. 3 is a plan view of the elongated cylindrical rod.

FIG. 4 is a perspective view of the grip.

### DETAILED DESCRIPTION OF THE INVENTION

In the preferred embodiment the present invention provides an elongated cylindrical rod type body. A tire valve stem cap-engaging receptacle is fixedly attached to the top of the elongated cylindrical rod. The tire valve stem cap-engaging receptacle is comprised of a socket type receptacle and is provided for receiving, removing, retaining and reinstalling the tire valve stem cap. A cylindrical shaped sleeve is fixedly attached circumferentially to the bottom end of the elongated cylindrical rod to facilitate grasping and rotation of the tire valve stem cap remover.

The foregoing summary of the preferred embodiment is intended to broadly outline the details and features of the present invention. The summary is neither intended to define the invention, which is measured by the claims, nor is it intended to be limiting as to the scope of the invention in any way. Further details and features of the present invention will become apparent from a consideration of the following specifications, descriptions, drawings, and claims.

### DETAILED DESCRIPTION OF THE PREFERED EMBODIMENT

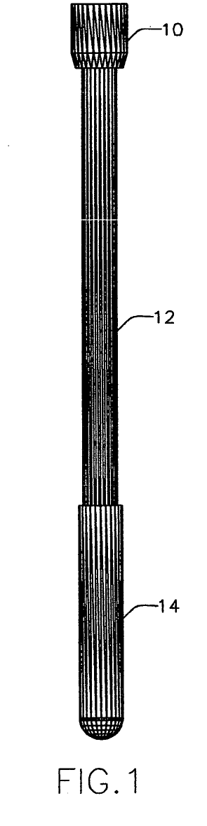

Referring to FIGS. 1 through 4 the tire valve stem cap remover of the present invention is shown. The tire stem valve cap remover includes an engaging receptacle 10 for removing, retaining, and reinstalling tire valve stem caps, and an elongated cylindrical rod 12 as the main body and a grip 14 for grasping and rotating the present invention during removal and reinstallation of tire valve stem caps.

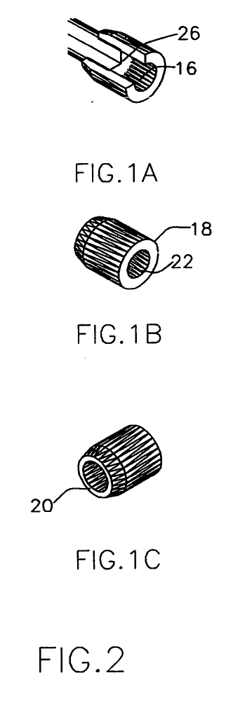

Referring to FIG. 2 the tire valve cap-engaging receptacle 10 is attached to the top portion of the elongated cylindrical rod 26. It is comprised of a socket-type cylindrical receptacle approximately 1.3125 inches in length. The top portion 18 of the tire valve cap-engaging receptacle 10 has an external diameter of approximately 1.125 inches tapering inwardly from approximately 1 inch from the top 18 to an external diameter of approximately 0.9492 inches at the bottom 20. The cylindrical cavity 16 of the cap-engaging receptacle 10 has an internal diameter at the top 18 of approximately 0.625 inches and increases in diameter to approximately 0.6875 inches at the bottom 20. The cap-engaging receptacle 10 is open 22 at the top 18 and extends vertically to a height of approximately 0.750 inches above the top portion 24 of the elongated cylindrical rod 12 thereby allowing the valve cap-engaging receptacle 10 to effectively receive and engage tire vale stem caps. Preferably, the tire valve cap-engaging receptacle 10 is manufactured of rubber and is substantially affixed to the top portion 24 of the elongated cylindrical rod 12 by means of adhesive. However, other materials such as metals or plastics may be used and may be attached by other means.

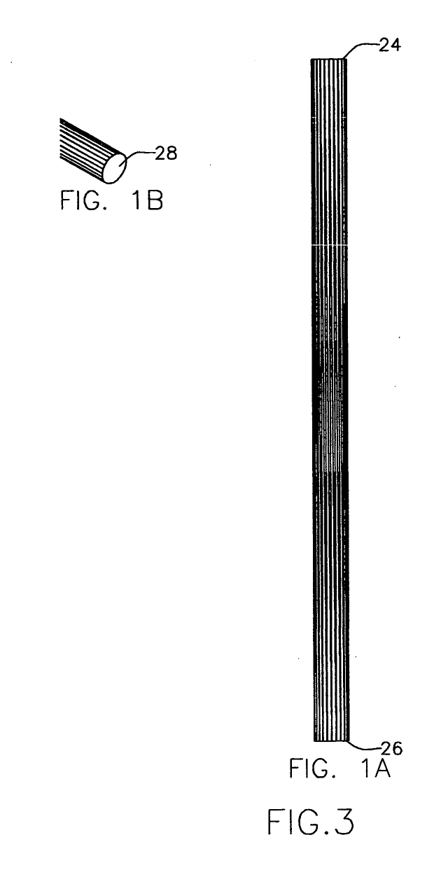

Referring to FIG. 3, the main body of the tire valve cap remover consists of an elongated cylindrical rod 12 with a solid core 28 and is approximately 14 inches in length with a diameter of approximately 0.6875 inch. Preferably, the elongated cylindrical rod is manufactured of fiberglass. However, the elongated body may be made of other materials such as metal and could be fashioned in variable shapes such as hexagonal.

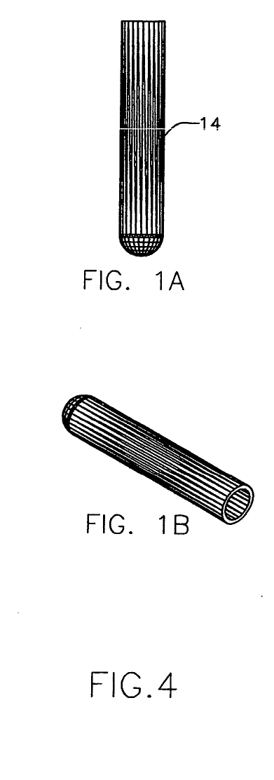

Referring to FIG. 4. To facilitate the twisting motion needed to remove and reinstall tire vale stem caps, a grip 14 is attached to the bottom portion of the inches in length, having an internal diameter of approximately 0.6875 inches and an external diameter of approximately 0.6875 inches. Preferably, the grip 14 is manufactured of plastic and attached circumferentially by adhesive to the bottom portion 26 of the elongated cylindrical rod 12. However, the grip may be made of other materials and attached by different means.

In use, the tire valve cap-engaging receptacle 10 receives the tire valve stem cap and the cylindrical cavity 16 of the socket-type cap-engaging receptacle 10 engages the tire valve stem cap. The tire valve stem cap can then be removed by twisting the elongated cylindrical rod 12 in a counter-clockwise motion. Once the tire valve stem cap has been removed from the valve stem, the socket-type cap-engaging receptacle 10 retains the tire valve stem cap. The tire valve stem cap can be reinstalled by aligning the retained tire valve stem cap with the tire valve stem and twisting in a clockwise motion.

Accordingly, the reader will see that the present invention can be used to access, loosen, remove, retain, and reinstall the tire valve stem cap that may be difficult without the advantages of the present invention. In addition, the present invention can be used easily and conveniently to access, loosen, remove, retain and reinstall the tire valve stem cap without the need to handle the cap directly. The present invention reduces the amount of direct handling of the cap thereby saving time and unnecessary frustration.

Although the description above contains many specificities, it is not intended to be limiting as to the scope of the invention but as merely providing illustrations of some of the presently preferred embodiments of this invention. It will be apparent to anyone skilled in the art that the same results could be achieved by using various shapes, designs, or materials, and that the improvements provided by the present invention could be adapted to any conventional tire air pressure gauge or valve stem tool.

Thus, the scope of the invention should be determined by the appended claims rather than by the descriptions and examples given.

### Drawings—Refernce Numerals

10 Cap-engaging receptacle
12 Elongated cylindrical rod
14 Grip
16 Cylindrical cavity
18 Top of cap engaging receptacle
20 Bottom of cap engaging receptacle
22 Open end
24 Top of cylindrical rod
26 Bottom of cylindrical rod

1. A hand held device for accessing, removing, retaining and reinstalling the tire valve stem cap on a plural arrangement of pneumatic tires mounted on an axel with the tires at the end of the axel comprising:
a.) an elongated cylindrical rod having a top and a bottom end.
b.) a cap-engaging receptacle for substantially receiving and engaging a tire valve stem cap thereby facilitating access, removal, retaining and reinstalling of said tire valve stem cap.

2. The cap-engaging receptacle is comprised of a socket-type receptacle with open top end where through a tire valve cap is substantially received.

3. The cap-engaging and receiving receptacle being attached substantially at one end of the said elongated cylindrical rod.

4. The cap-engaging receptacle has a predetermined cylindrical cavity whereby tire valve stem caps are effectively received and engaged.

5. The present invention as described in claim 1 further includes a plastic grip whereby the tire stem valve cap remover can be grasped and twisted thereby facilitating removal and reinstallation of the valve stem cap.
